(19) United States
(12) Patent Application Publication
(10) Pub. No.: US 2026/0269353 A1
(43) Pub. Date: Sep. 10, 2026

(54) BATTERY MODULE

(71) Applicant: HONDA MOTOR CO., LTD., Tokyo (JP)

(72) Inventors: Nobuyuki AKAISHI, Saitama (JP); Daichi WATANABE, Saitama (JP)

(21) Appl. No.: 19/555,906

(22) Filed: Mar. 4, 2026

(30) Foreign Application Priority Data
Mar. 7, 2025 (JP) 2025-036109

(51) Int. Cl. H01M 10/613; H01M 10/6554; H01M 50/507

(52) U.S. Cl. CPC H01M 10/613; H01M 10/6554; H01M 50/507

(57) ABSTRACT

A battery module includes a plurality of battery cells stacked in a predetermined X direction. Each of the battery cells includes a cell body, a Y1-side tab protruding from the cell body toward a Y1 side, and a Y2-side tab protruding from the cell body toward a Y2 side. The battery module further includes a Y1-side bus bar, a Y2-side bus bar, a first channel, and a second channel. The Y1-side bus bar is electrically connected to the Y1-side tub. The Y2-side bus bar is electrically connected to the Y2-side tab. In the first channel, a coolant flows through a path that cools the Y1-side bus bar and the cell body. In the second channel, a coolant flows through a path that cools the Y2-side bus bar and the cell body.

### CROSS-REFERENCE TO RELATED APPLICATIONS

This application is based on and claims the benefit of priority from Japanese Patent Application No. 2025-036109, filed on 7 Mar. 2025, the content of which is incorporated herein by reference.

### BACKGROUND OF THE INVENTION

### Field of the Invention

The present invention relates to a battery module including a plurality of battery cells.

### Related Art

In recent years, the popularity of electrically powered vehicles such as electric vehicles (EVs) and hybrid electric vehicles (HEVs) has been increasing from the perspective of reducing carbon dioxide emissions and mitigating negative impacts on the global environment, for example. Some battery modules that are mounted in electrically powered vehicles and the like include a plurality of battery cells. The battery cells are stacked in an X direction, and each have a cell body and tabs that protrude from the cell body in a Y direction.

Patent Document 1: Japanese Unexamined Patent Application, Publication No. 2023-148244

### SUMMARY OF THE INVENTION

The present inventors have taken note of the following issues associated with batteries such as described above. The tab temperature rises, for example, in fast battery charging and in battery discharging during high-load driving. Once the tab temperature reaches the limit of the allowable range thereof, it is necessary to reduce the current to prevent the tab temperature from rising further. As such, the tab temperature can be a rate-limiting factor in fast battery charging and in battery discharging during high-load driving.

Therefore, it is preferable to suppress the temperature rise of the tabs. In addition, it is preferable that the temperature rise of the cell body can be suppressed.

The present invention has been made in view of the above circumstances, and an object of the present invention is to suppress a temperature rise of a tab and a temperature rise of a cell body.

The present inventors found that providing a channel in which a coolant flows through a predetermined path allows for achieving the object of the present invention, and thus arrived at the present invention. The present invention is directed to a battery module according to first to ninth aspects described below.

(1) According to the first aspect, a battery module includes: a plurality of battery cells stacked in a predetermined X direction,

each of the plurality of battery cells including a cell body, a Y1-side tab protruding from the cell body toward a Y1 side that is one side in a Y direction orthogonal to the X direction, and a Y2-side tab protruding from the cell body toward a Y2 side that is an opposite side to the Y1 side;

a Y1-side bus bar to which the Y1-side tab is electrically connected;

a Y2-side bus bar to which the Y2-side tab is electrically connected;

a first channel in which a coolant flows through a path that cools the Y1-side bus bar and the cell body; and

a second channel in which a coolant flows through a path that cools the Y2-side bus bar and the cell body.

The above configuration makes it possible to suppress a temperature rise of the Y1-side tab and a temperature rise of the cell body by the first channel. Further, the above configuration makes it possible to suppress a temperature rise of the Y2-side tab and a temperature rise of the cell body by the second channel. Thus, the above configuration makes it possible to suppress not only the temperature rise of the Y1-side tab and Y2-side tab but also the temperature rise of the cell body.

(2) According to the second aspect, in the battery module of the first aspect,

the first channel includes a path through which the coolant flows so as to cool the Y1-side bus bar, and thereafter, the cell body, and

the second channel includes a path through which the coolant flows so as to cool the Y2-side bus bar, and thereafter, the cell body.

The above configuration can be suitably employed in a case where it is desired to preferentially cool the tabs rather than the cell body.

(3) According to the third aspect, in the battery module of the first or second aspect,

one side in the X direction is referred to as an X1 side, and an opposite side to the X1 side is referred to as an X2 side,

when counting from the X1 side toward the X2 side, the Y1-side tab of each odd-numbered battery cell and the Y1-side tab of the battery cell next to the odd-numbered battery cell toward the X2 side are electrically connected to each other via the Y1-side bus bar, and

when counting from the X1 side toward the X2 side, the Y2-side tab of each even-numbered battery cell and the Y2-side tab of the battery cell next to the even-numbered battery cell toward the X2 side are electrically connected to each other via the Y2-side bus bar.

The above configuration can be suitably employed in a case where it is desired to electrically connect in series a plurality of battery cells stacked in the X direction to each other.

(4) According to the fourth aspect, the battery module of any one of the first to third aspects further includes:

a Y1-side bus bar holder that holds a plurality of the Y1-side bus bars;

a Y2-side bus bar holder that holds a plurality of the Y2-side bus bars; and

a cooling plate provided between the Y1-side bus bar holder and the Y2-side bus bar holder. The first channel passes through an inside of the Y1-side bus bar holder, an inside of the cooling plate, and an inside of the Y2-side bus bar holder, and

the second channel passes through the inside of the Y2-side bus bar holder, the inside of the cooling plate, and the inside of the Y1-side bus bar holder.

Due to this configuration, the first channel and the second channel can be efficiently installed.

(5) According to the fifth aspect, in the battery module of the fourth aspect,

a plurality of the cell bodies have sealing portions on a one-by-one basis, the sealing portions protruding in a direction orthogonal to the X direction, and

at least a portion of the cooling plate is disposed between the sealing portions of the battery cells adjacent to each other in the X direction.

Due to this configuration, the cooling plate can be efficiently installed using a space between the sealing portions.

(6) According to the sixth aspect, in the battery module of the fourth or fifth aspects,

the Y1-side bus bar holder has a first inlet as an inlet for the coolant that is to flow into the first channel, and the Y2-side bus bar holder has a first outlet as an outlet for the coolant that has passed through the first channel, the first outlet being provided at a position higher than the first inlet, and

the Y2-side bus bar holder has a second inlet as an inlet for the coolant that is to flow into the second channel, and the Y1-side bus bar holder has a second outlet as an outlet for the coolant that has passed through the second channel, the second outlet being provided at a position higher than the second inlet.

Due to the above configuration, only a portion of the coolant that has entered the first channel through the first inlet and overflowed the first channel is let out from the first outlet. Therefore, air in the first channel can be easily purged, whereby the cooling efficiency can be improved. Similarly to this, air in the second channel can be easily purged, whereby the cooling efficiency can be improved.

(7) According to the seventh aspect, in the battery module of any one of the first to sixth aspects,

each channel of a plurality of the first channels and a plurality of the second channels includes an X1-side branch channel and an X2-side branch channel arranged side by side in the X direction, the X1-side branch channel cools one of two cell bodies adjacent to the channel, and the X2-side branch channel cools the other of the two cell bodies.

Due to the above configuration, the two cell bodies adjacent to each of the channels can be efficiently cooled.

(8) According to the eighth aspect, in the battery module of any one of the first to seventh aspects, the battery cells are all-solid-state batteries each including therein a solid electrolyte layer.

For example, in the case where each battery cell is an all-solid-state battery, because the operating temperature range is wide, the temperatures of the tabs are likely to reach the limit of an allowable range before the temperature of a portion of the cell body reaches the limit of the allowable range. In addition, the temperature of the cell body increases as the temperatures of the tabs increase. Therefore, in the battery module in which the battery cells having a wide operating temperature range are stacked in the X direction, the above configuration makes it possible to suppress the temperature rise of the tabs and the temperature rise of the cell bodies.

(9) According to the ninth aspect, in the battery module of any one of the first to eighth aspects, the battery cells each include an electrolytic solution.

For example, in a case where the battery cells are lithium-ion batteries, the battery cells often include an electrolytic solution. Therefore, in the battery module in which battery cells having high versatility are stacked in the X direction, the above configuration makes it possible to suppress the temperature rise of the tabs and the temperature rise of the cell bodies.

As described above, the configuration of the first aspect makes it possible to suppress the temperature rise of the tabs and the temperature rise of the cell bodies. The configurations of the second to ninth aspects according to the first aspect exert respective additional effects.

### BRIEF DESCRIPTION OF THE DRAWINGS

FIG. 1 is a perspective view illustrating a battery module according to a first embodiment;

FIG. 2 is a perspective view illustrating a portion of FIG. 1 on an enlarged scale;

FIG. 3 is a perspective view illustrating an inside of the battery module;

FIG. 4 is a perspective view illustrating a portion of FIG. 3 on an enlarged scale;

FIG. 5 is a perspective view of an upper portion of FIG. 4 viewed from a slightly different angle;

FIG. 6 illustrates the inside of the battery module as viewed from a Y1 side;

FIG. 7 illustrates the inside of the battery module as viewed from a Y2 side;

FIG. 8 is a perspective view illustrating a first channel and a second channel;

FIG. 9 is a perspective view illustrating the first channel;

FIG. 10 is a perspective view illustrating the second channel;

FIG. 11 is a perspective view illustrating an initial stage of an assembly process of assembling the battery module;

FIG. 12 is a perspective view illustrating a subsequent stage of the assembly process;

FIG. 13 is a perspective view illustrating a further subsequent stage of the assembly process;

FIG. 14 is a schematic diagram illustrating a cross section of an intermediate portion in a vertical direction of the battery module;

FIG. 15 is a schematic diagram illustrating a corresponding cross section of a modification;

FIG. 16 is a schematic diagram illustrating a corresponding cross section of another modification; and

FIG. 17 is a schematic diagram illustrating a corresponding cross section of yet another modification.

### DETAILED DESCRIPTION OF THE INVENTION

The following describes embodiments of the present invention with reference to the accompanying drawings. However, the present invention is not in any way limited to the following embodiments, and appropriate modifications can be made within the scope of the spirit of the present invention to practice the present invention.

### First Embodiment

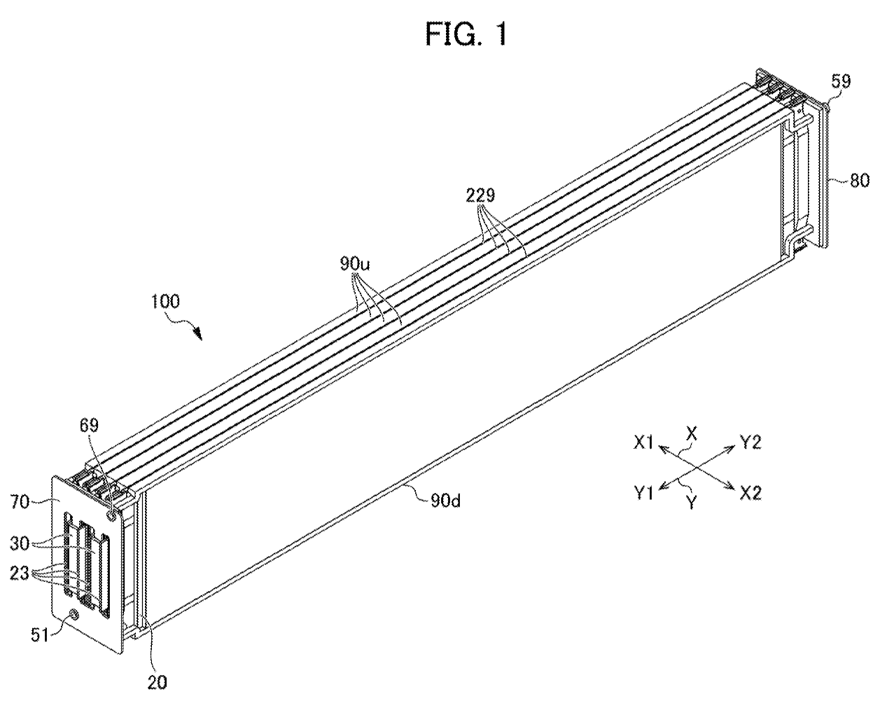

In the following, two directions that are orthogonal to each other in a horizontal plane are referred to as "X direction" and "Y direction", as illustrated in in FIG. 1. One side in the X direction is referred to as "X1 side" and a side opposite thereto is referred to as "X2 side". One side in the Y direction is referred to as "Y1 side" and a side opposite thereto is referred to as "Y2 side".

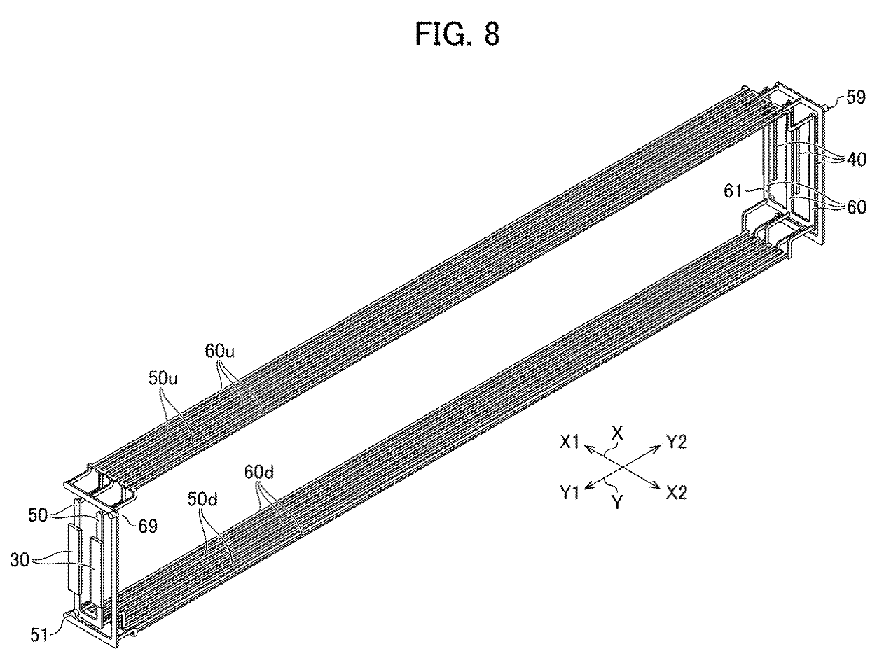

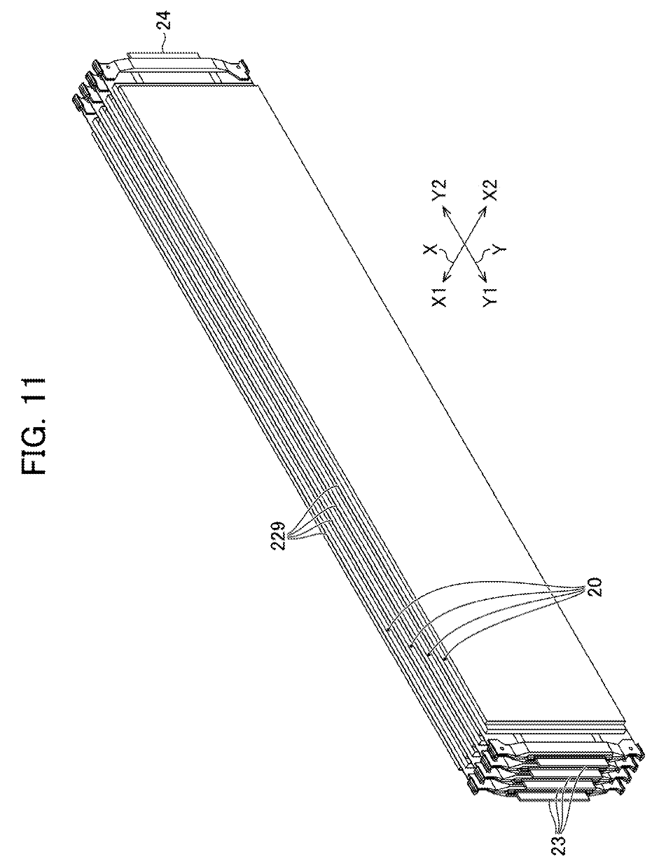

As illustrated in FIG. 11, a battery module 100 includes a plurality of battery cells 20. The drawings illustrate four battery cells 20, but the number of battery cells 20 may be larger than four. As illustrated in FIG. 1, the battery module 100 further includes a Y1-side bus bar holder 70, a Y2-side bus bar holder 80, upper cooling plates 90u, and lower cooling plates 90d. Further, as illustrated in FIG. 8, the battery module 100 includes first channels 50 and second channels 60.

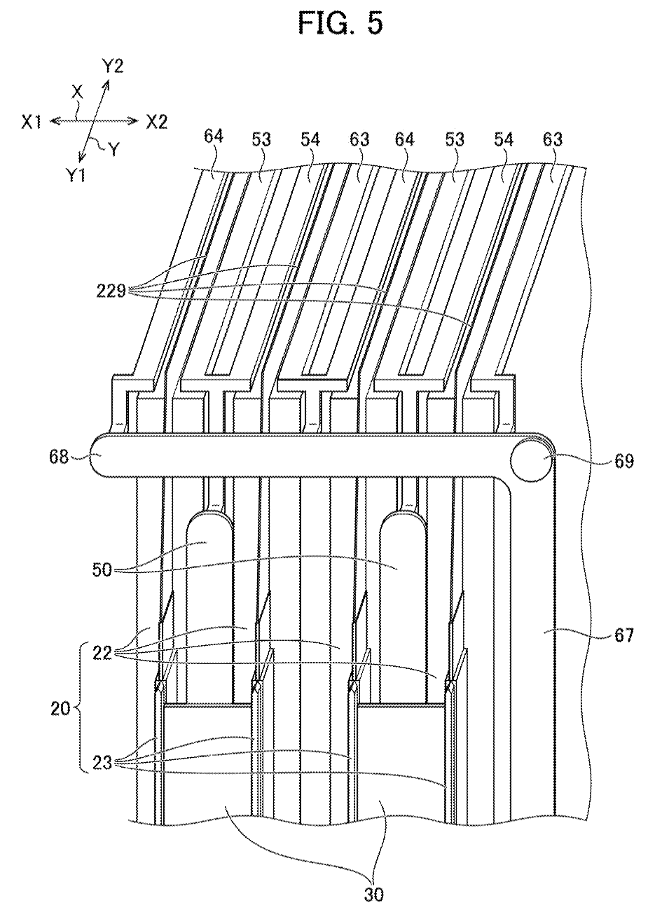

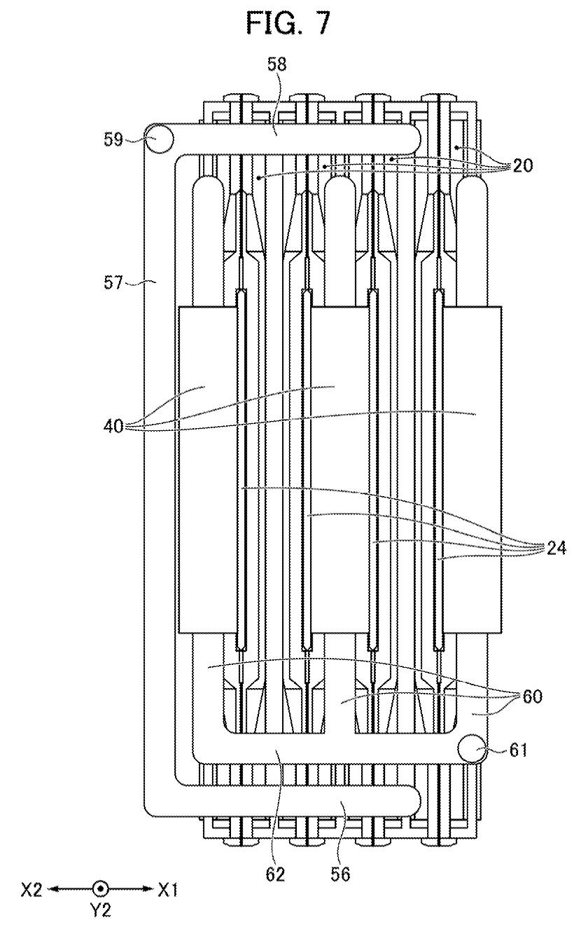

As illustrated in FIG. 11, the plurality of battery cells 20 are stacked in the X direction. Each battery cell 20 includes a solid electrolyte. As illustrated in FIG. 5, each battery cell 20 includes a cell body 22 extending in the vertical direction and the Y direction, and a Y1-side tab 23 protruding toward the Y1 side from an intermediate portion in the vertical direction of the cell body 22. Further, as illustrated in FIG. 7, each battery cell 20 includes a Y2-side tab 24 protruding toward the Y2 side from an intermediate portion in the vertical direction of the cell body 22.

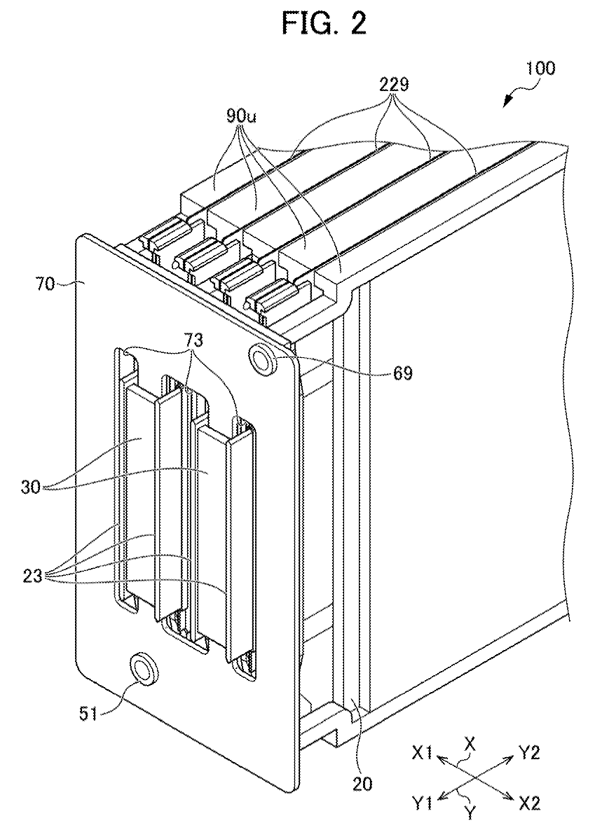

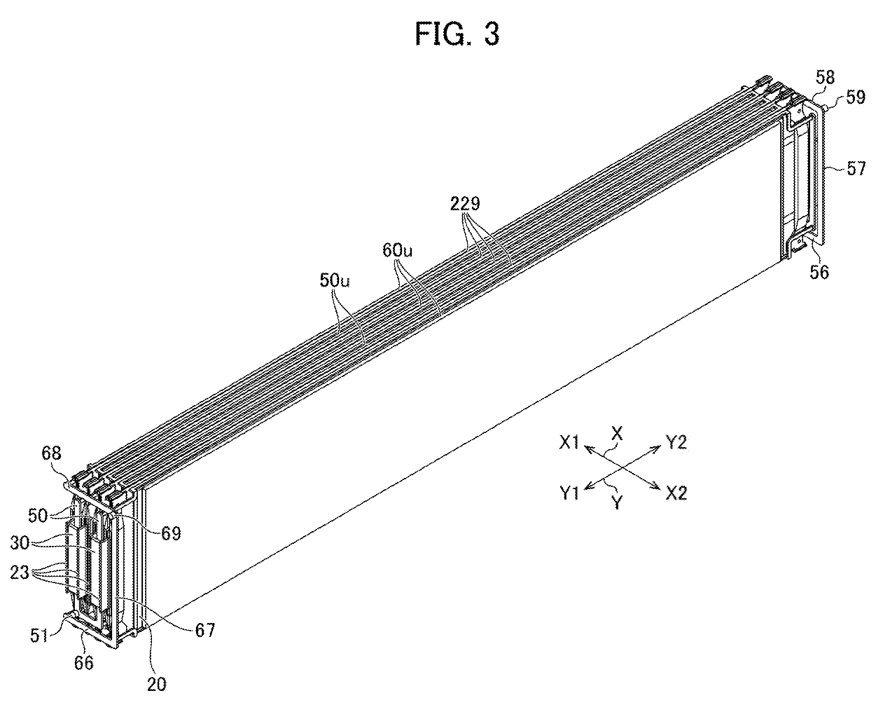

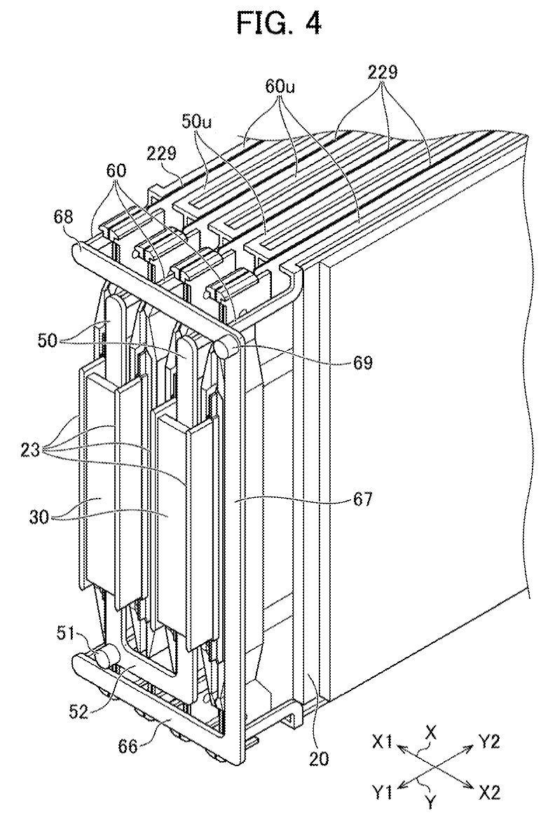

As illustrated in FIG. 2, the Y1-side bus bar holder 70 holds a plurality of Y1-side bus bars 30 that are disposed side by side in the X direction. The drawings illustrate two Y1-side bus bars 30 in correspondence with the number of battery cells 20, i.e., four. However, in a case where the number of battery cells 20 is an even number greater than four, the number of Y1-side bus bars 30 is half of the number of battery cells 20. In a case where the number of battery cells 20 is an odd number greater than four, the number of Y1-side bus bars 30 is half of the number obtained by adding one to the number of battery cells 20.

The Y2-side bus bar holder 80 illustrated in FIG. 1 holds a plurality of Y2-side bus bars 40 that are arranged side by side in the X direction, as illustrated in in FIG. 7 The drawings illustrate three Y2-side bus bars 40 in correspondence with the number of battery cells 20, i.e., four. However, in a case where the number of battery cells 20 is an even number greater than four, the number of Y2-side bus bars 40 is the number obtained by adding one to half of the number of battery cells 20. In a case where the number of battery cells 20 is an odd number greater than four, the number of Y2-side bus bars 40 is half of the number obtained by adding one to the number of battery cells 20.

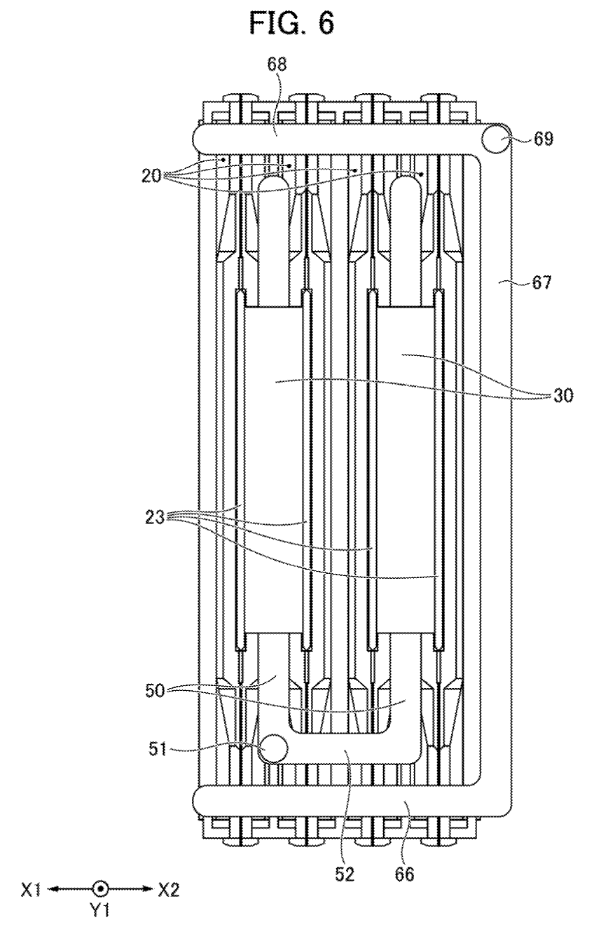

As illustrated in FIG. 6, when counting from the X1 side toward the X2 side, the Y1-side tab 23 of each odd-numbered battery cell 20 and the Y1-side tab 23 of the battery cell 20 next to the odd-numbered battery cell 20 toward the X2 side are electrically connected to each other via the Y1-side bus bar 30. As illustrated in FIG. 7, when counting from the X1 side toward the X2 side, the Y2-side tab 24 of each even-numbered battery cells 20 and the Y2-side tab 24 of the battery cell 20 next to the even-numbered battery cell 20 toward the X2 side are electrically connected to each other via the Y2-side bus bar 40.

As illustrated in FIG. 1, the upper cooling plates 90u are provided between an upper end portion of the Y1-side bus bar holder 70 and an upper end portion of the Y2-side bus bar holder 80. Therefore, the upper cooling plates 90u are provided along upper end portions of the cell bodies 22. In the drawings, the upper cooling plates 90u are separate plates arranged in the X direction, but may be configured as one continuous plate.

The lower cooling plates 90d are provided between a lower end portion of the Y1-side bus bar holder 70 and a lower end portion of the Y2-side bus bar holder 80. Therefore, the lower cooling plates 90d are provided along lower end portions of the cell bodies 22. Similarly to the upper cooling plates 90u, the lower cooling plates 90d may be separate plates arranged in the X direction or may be configured as one continuous plate.

Each cell body 22 illustrated in FIG. 5 has an exterior covering composed of a laminate film. Each of the cell bodies 22 has a laminate film sealing portion 229 protruding in the vertical direction and the Y direction from an intermediate portion in the X direction. The laminate film sealing portion 229 is a portion in which edges of the laminate films are bonded to each other. The "laminate film sealing portion 229" may be simply referred to as a "sealing portion". As illustrated in FIG. 2, at least a portion of each upper cooling plate 90u is disposed between the laminate film sealing portions 229 of the battery cells 20 adjacent to each other in the X direction. Likewise, at least a portion of each lower cooling plate 90d is disposed between the laminate film sealing portions 229 of the battery cells 20 adjacent to each other in the X direction.

Next, the first channels 50 and the second channels 60 shown in FIG. 8 will be described.

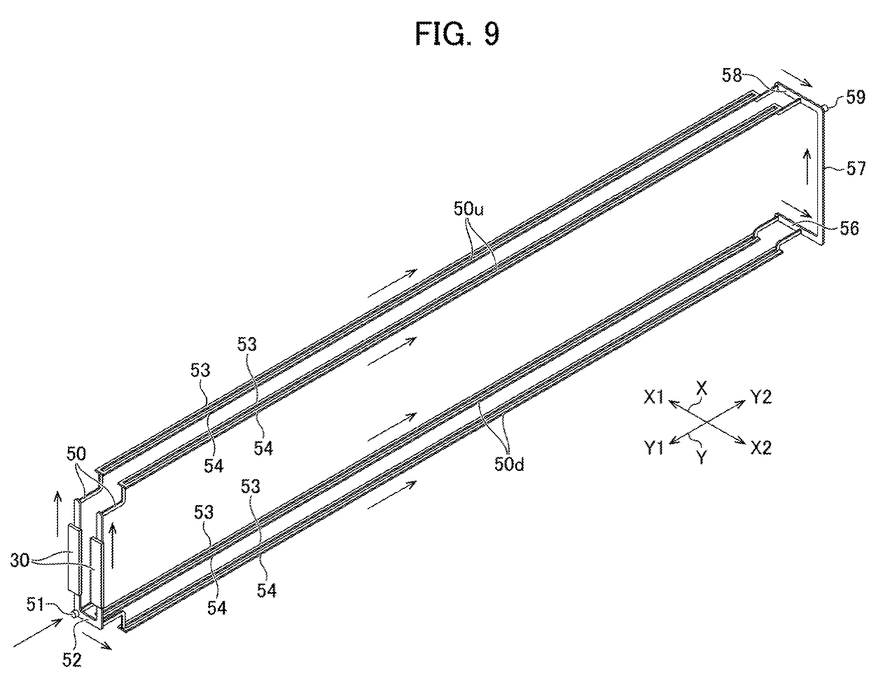

First, the first channels 50 will be described. As illustrated in FIG. 5, the first channels 50 are provided for the Y1-side bus bars 30 on a one-to-one basis. Therefore, when viewed from the Y1 side or the upper side, each first channel 50 is provided between the battery cells 20 electrically connected to each other via the Y1-side bus bar 30. As illustrated in FIG. 9, each first channel 50 includes an upper path 50u and a lower path 50d.

The upper path 50u passes through the inside of the Y1-side bus bar holder 70, then, passes through the inside of the upper cooling plate 90u, and reaches the inside of the Y2-side bus bar holder 80. Therefore, a coolant flowing through the upper path 50u cools the Y1-side bus bar 30, and thereafter, the upper portions of the cell bodies 22. On the other hand, the lower path 50d passes through the inside of the lower cooling plate 90d and reaches the inside of the Y2-side bus bar holder 80. Therefore, the coolant flowing through the lower path 50d cools the lower portions of the cell bodies 22.

In a lower end portion of the Y1-side bus bar holder 70 illustrated in FIG. 2, an upstream end of the upper path 50u and an upstream end of the lower path 50d of each first channel 50 communicate with each other as illustrated in FIG. 9. Further, in the lower end portion of the Y1-side bus bar holder 70, upstream ends of the first channels 50 arranged side by side in the X direction communicate with each other via a communication path 52.

In a lower end portion of the Y2-side bus bar holder 80 illustrated in FIG. 1, downstream ends of the lower paths 50d arranged side by side in the X direction communicate with each other via a lower communication path 56, as illustrated in FIG. 9. In an upper end portion of the Y2-side bus bar holder 80, downstream ends of the upper paths 50u arranged side by side in the X direction communicate with each other via an upper communication path 58. Further, in an end portion of the Y2-side bus bar holder 80 in the X direction, the lower communication path 56 and the upper communication path 58 communicate with each other via a vertical communication path 57.

As illustrated in FIG. 1, a first inlet 51 as an inlet for the coolant that is to flow into the first channels 50 is provided in a lower end portion of the Y1-side bus bar holder 70. Further, a first outlet 59 as an outlet for the coolant that has passed through the first channels 50 is provided in an upper end portion of the Y2-side bus bar holder 80. Thus, the first outlet 59 is provided at a position higher than the first inlet 51.

Hereinafter, the upper cooling plates 90u and the lower cooling plates 90d illustrated in FIG. 1 are referred to as "upper and lower cooling plates 90u and 90d".

As illustrated in FIG. 9, in each of the upper and lower cooling plates 90u and 90d, the first channel 50 branches into an X1-side branch channel 53 and an X2-side branch channel 54, and then, the branch channels merge with each other. Therefore, each first channel 50 includes the X1-side branch channel 53 and the X2-side branch channel 54 arranged side by side in the X direction in a corresponding one of the upper and lower cooling plates 90u and 90d. As illustrated in FIG. 5, the coolant flowing through the X1-side branch channel 53 cools one cell body 22, of two cell bodies 22 arranged side by side in the X direction, that is closer to the X1 side. On the other hand, the coolant flowing through the X2-side branch channel 54 cools the other cell body 22, of the two cell bodies 22, that is closer to the X2 side.

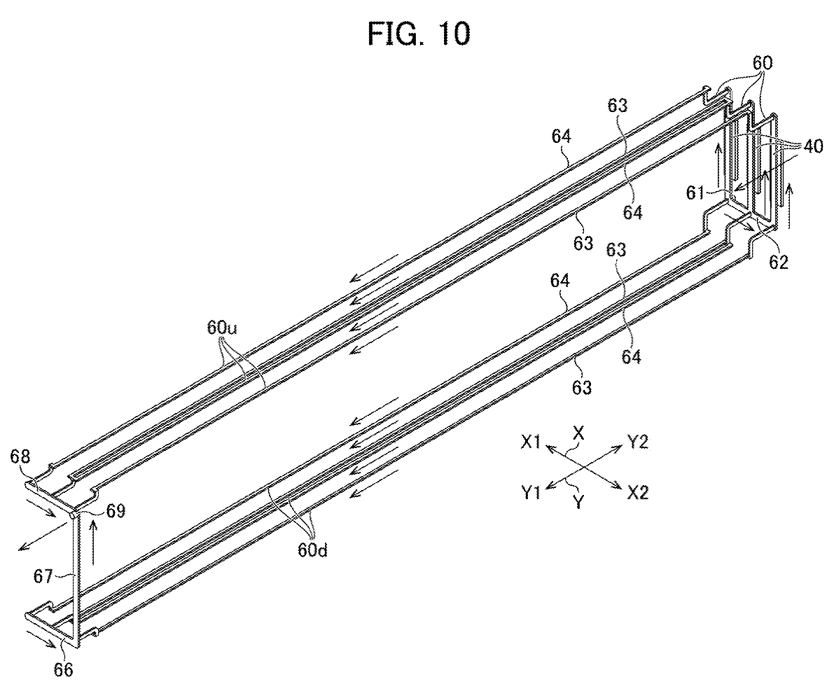

Next, the second channels 60 illustrated in FIG. 10 will be described. Each second channel 60 includes an upper path 60u and a lower path 60d. The Y2-side bus bar holder 80 is provided with a second inlet 61 and a communication path 62. The Y1-side bus bar holder 70 is provided with a lower communication path 66, a vertical communication path 67, an upper communication path 68, and a second outlet 69. In the upper and lower cooling plates 90u and 90d, each second channel 60 branches into an X1-side branch channel 63 and an X2-side branch channel 64, and then, the branch channels merge with each other.

A further specific description of the second channels 60 is the same as the above description of the first channels 50 with the following replacement. The word "first" is replaced with "second", and "Y1-side" and "Y2-side" is replaced with the other. Further, the reference numerals are replaced with the corresponding reference numerals, and the reference numerals in the drawings are replaced with the corresponding reference numerals.

Next, the present embodiment will be described in more detail.

As illustrated in FIG. 2, the Y1-side bus bar holder 70 has slots 73 that have the Y1-side tabs 23 inserted therethrough, extend in the vertical direction, and are arranged side by side in the X direction. The Y1-side bus bars 30 are held toward the Y1 side between the slots 73. Likewise, the Y2-side bus bar holder 80 illustrated in FIG. 1 also has slots (not shown) that have the Y2-side tabs 24 inserted therethrough and are arranged side by side in the X direction. The Y2-side bus bars 40 illustrated in FIG. 7 are held toward the Y2 side between the slots (not shown).

Hereinafter, for the battery cells 20 illustrated in FIG. 11, an arrangement in which the tab on a negative electrode side is defined as the Y1-side tab 23 and the tab on a positive electrode side is defined as the Y2-side tab 24 is referred to as a "negative-positive arrangement". Further, for the battery cells 20, an arrangement in which the tab on the positive electrode side is defined as the Y1-side tab 23 and the tab on the negative electrode side is defined the Y2-side tab 24 is referred to as "positive-negative arrangement". In the battery module 100, the battery cells 20 in the negative-positive arrangement and the battery cells 20 in the positive-negative arrangement alternate with each other in the X direction.

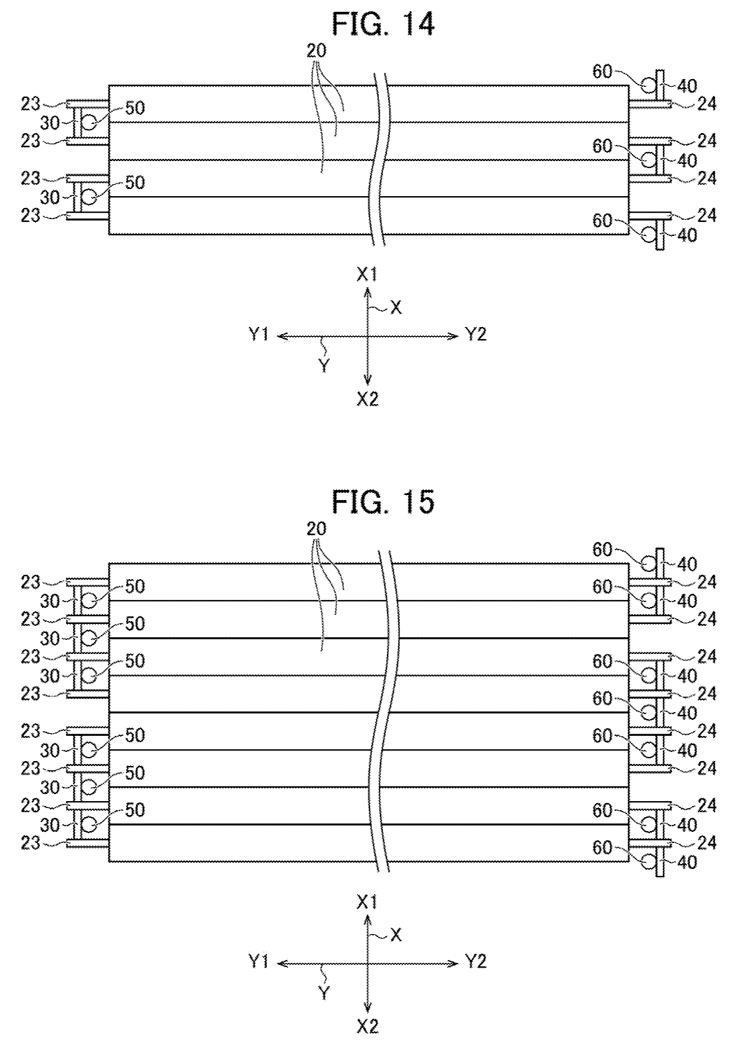

Therefore, each Y1-side bus bar 30 illustrated in FIG. 6 electrically connects a negative electrode-side tab as the Y1-side tab 23 adjacent to the X1-side end of the Y1-side bus bar 30 to a positive electrode-side tab as the Y1-side tab 23 adjacent to the X2-side end of the Y1-side bus bar 30. Likewise, each Y2-side bus bar 40 illustrated in FIG. 7 electrically connects a negative electrode-side tab as the Y2-side tab 24 adjacent to the X1-side end of the Y2-side bus bar 40 to a positive electrode-side tab as the Y2-side tab 24 adjacent to the X2-side end of the Y2-side bus bar 40. Therefore, as illustrated in FIG. 14, the battery cells 20 arranged side by side in the X direction are electrically connected in series.

A positive electrode-side tab as the Y2-side bus bar 40 closest to the X1 side is electrically connected to a positive electrode terminal provided for the entirety of the battery module 100. A negative electrode-side tab as the Y2-side bus bar 40 closest to the X2 side is electrically connected to a negative electrode terminal provided for the entirety of the battery module 100.

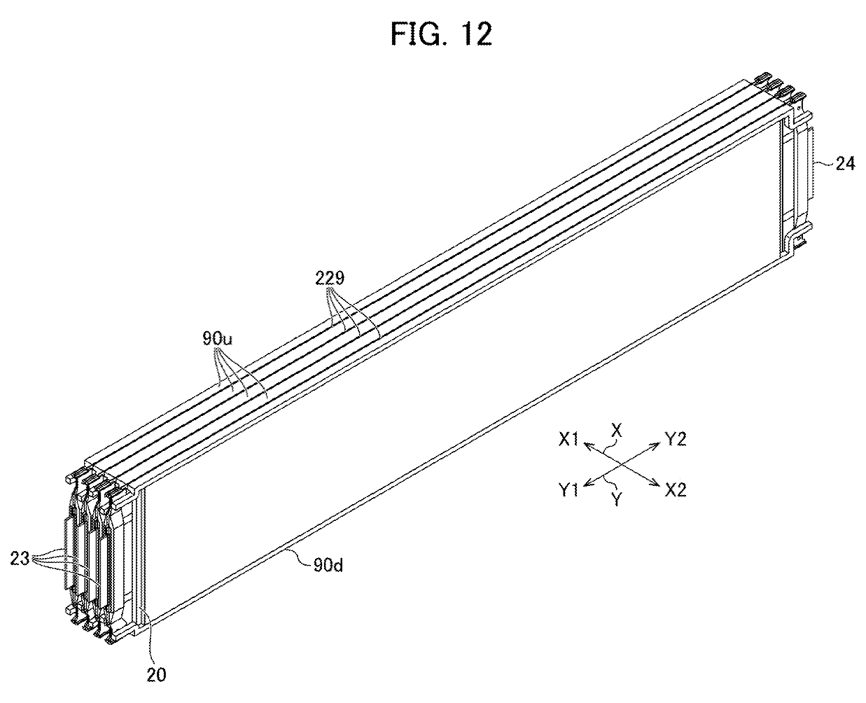

The battery module 100 described above is assembled by the following procedure. First, as illustrated in FIG. 11, a plurality of battery cells 20 are stacked in the X direction. In the subsequent step, as illustrated in FIG. 12, the upper cooling plates 90u are attached to the upper sides of the plurality of battery cells 20. As a result, a portion in which the first channels 50 and the second channels 60 cool the upper end portions of the battery cells 20 is produced. In this step, the lower cooling plates 90d are attached to the lower sides of the plurality of battery cells 20. As a result, a portion in which the first channels 50 and the second channels 60 cool the lower end portions of the battery cells 20 is produced.

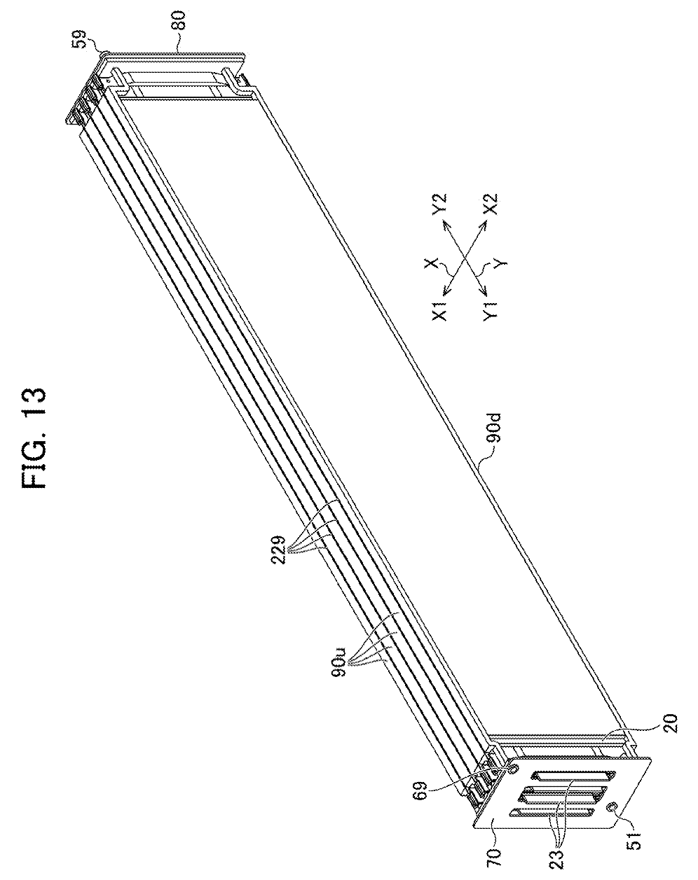

In the subsequent step, as illustrated in FIG. 13, the Y1-side bus bar holder 70 is attached to the Y1 side-facing ends of the plurality of battery cells 20. Thus, a portion in which the first channels 50 cool the Y1-side bus bars 30 is produced. In this step, the Y2-side bus bar holder 80 is attached to the Y2 side-facing ends of the plurality of battery cells 20. Thus, a portion in which the second channels 60 cool the Y2-side bus bars 40 is produced.

In the subsequent step, the Y1-side tabs 23 illustrated in FIG. 2 are each welded to the adjacent Y1-side bus bar 30. In this step, the Y2-side tabs 24 illustrated in FIG. 7 are each welded to the adjacent Y2-side bus bar 40. In the above-described manner, the battery module 100 is completed.

The following is a summary of the configuration and effects of the present embodiment.

Hereinafter, the Y1-side tabs 23 and the Y2-side tabs 24 illustrated in FIG. 11 are referred to as "the tabs 23, 24 on the opposite sides in the Y direction". The Y1-side bus bar 30 illustrated in FIG. 6 and the Y2-side bus bar 40 illustrated in FIG. 7 are referred to as "the bus bars 30, 40 on the opposite sides in the Y direction".

As illustrated in FIG. 9, in each first channels 50, the coolant flows through a path that cools the Y1-side bus bar 30 and the cell bodies 22. Therefore, each first channel 50 can suppress not only the temperature rise of the Y1-side tab 23 but also the temperature rise of the cell bodies 22. As illustrated in FIG. 10, in each second channel 60, a coolant flows through a path that cools the Y2-side bus bar 40 and the cell bodies 22. Therefore, each second channel 60 can suppress not only the temperature rise of the Y2-side tab 24 but also the temperature rise of the cell bodies 22. This feature makes it possible to suppress not only the temperature rise of the tabs 23, 24 on the opposite sides in the Y direction, but also the temperature rise of the cell bodies 22.

As illustrated in FIG. 9, the coolant flows through the upper path 50u of each first channel 50 so as to cool the Y1-side bus bar 30, and thereafter, the cell bodies 22. As illustrated in FIG. 10, the coolant flows through the upper path 60u of each second channel 60 so as to cool the Y2-side bus bar 40, and thereafter, the cell bodies 22. Due to this feature, the present embodiment can be suitably employed in a case where it is desired to preferentially cool the bus bars 30, 40 on the opposite sides in the Y direction rather than the cell bodies 22.

As illustrated in FIG. 6, when counting from the X1 side toward the X2 side, the Y1-side tab 23 of each odd-numbered battery cell 20 and the Y1-side tab 23 of the battery cell 20 next to the odd-numbered battery cell 20 toward the X2 side are electrically connected to each other via the Y1-side bus bar 30. As illustrated in FIG. 7, when counting from the X1 side toward the X2 side, the Y2-side tab 24 of each even-numbered battery cells 20 and the Y2-side tab 24 of the battery cell 20 next to the even-numbered battery cell 20 toward the X2 side are electrically connected to each other via the Y2-side bus bar 40. Due to this feature, the present embodiment can be suitably employed in a case where it is desired to electrically connect in series the plurality of battery cells 20 stacked in the X direction.

The upper paths 50u of the first channels 50 illustrated in FIG. 9 pass through the inside of the Y1-side bus bar holder 70 and the inside of the upper cooling plates 90u. The upper paths 60u of the second channels 60 illustrated in FIG. 10 pass through the inside of the Y2-side bus bar holder 80 and the inside of the upper cooling plates 90u. Due to this feature, the upper paths 50u of the first channels 50 and the upper paths 60u of the second channels 60 can be efficiently installed.

As illustrated in FIG. 2, at least a portion of each upper cooling plate 90u is disposed between the laminate film sealing portions 229 of the battery cells 20 adjacent to each other in the X direction. Therefore, the upper cooling plates 90u can be efficiently installed using the spaces between the laminate film sealing portions 229. Likewise, at least a portion of each lower cooling plate 90d is disposed between laminate film sealing portions 229 of the battery cells 20 adjacent to each other in the X direction. Therefore, the lower cooling plates 90d can be efficiently installed using the spaces between the laminate film sealing portions 229.

As illustrated in FIG. 1, the first outlet 59 is provided at a position higher than the first inlet 51. Therefore, only a portion of the coolant that has entered the first channels 50 through the first inlet 51 and overflowed the first channels 50 is let out from the first outlet 59. Therefore, air in the first channels 50 can be easily purged, whereby the cooling efficiency can be improved.

Likewise, as illustrated in FIG. 10, the second outlet 69 is provided at a position higher than the second inlet 61. Therefore, air in the second channels 60 can also be easily purged, whereby the cooling efficiency can be improved.

As illustrated in FIG. 5, each first channel 50 is adjacent to two cell bodies 22 and includes the X1-side branch channel 53 and the X2-side branch channel 54 arranged side by side in the X direction. The X1-side branch channel 53 cools one of the two cell bodies 22 that is closer to the X1 side, and the X2-side branch channel 54 cools the other of the two cell bodies 22 that is closer to the X2 side. Thus, each of the first channels 50 can efficiently cool two cell bodies 22.

Likewise, each second channel 60 is adjacent to two cell bodies 22 and includes the X1-side branch channel 63 and the X2-side branch channel 64 arranged side by side in the X direction. The X1-side branch channel 63 cools one of the two cell bodies 22 that is closer to the X1 side, and the X2-side branch channel 64 cools the other of the two cell bodies 22 that is closer to the X2 side. Thus, each of the second channels 60 can efficiently cool two cell bodies 22.

Each of the battery cells 20 illustrated in FIG. 11 includes a solid electrolyte. For example, in the case where each battery cell 20 is an all-solid-state battery, because the operating temperature range is wide, the temperatures of the tabs 23, 24 on the opposite sides in the Y direction are likely to reach the limit of an allowable range before the temperature of a portion of the cell bodies 22 reaches the limit of the allowable range. In addition, the temperatures of the cell bodies 22 increase as the temperatures of the tabs 23, 24 on the opposite sides in the Y direction increase. Therefore, in the battery module 100 in which the battery cells 20 having a wide operating temperature range are stacked in the X direction, it is possible to suppress the temperature rise of the tabs 23, 24 on the opposite sides in the Y direction and the temperature rise of the cell bodies 22.

### Other Embodiments

The embodiment described above can be modified as follows, for example.

The battery module 100 of the first embodiment illustrated in FIG. 1 may be implemented in a state of being rotated by 90° or in a state of being inclined by a predetermined angle. Specifically, the battery module 100 may be implemented in a state in which the direction referred to as the vertical direction in the first embodiment becomes the horizontal direction, or in a state in which the direction referred to as the vertical direction in the first embodiment becomes a direction oblique with respect to the vertical direction.

Each battery cell 20 illustrated in FIG. 11 may include an electrolytic solution instead of or in addition to the solid electrolyte.

As illustrated in FIG. 14, in the first embodiment, the Y1-side tabs 23 of each set of two adjacent battery cells 20 are electrically connected to each other via the Y1-side bus bar 30. The Y2-side tabs 24 of each set of two adjacent battery cells 20 that is shifted by one battery cell from the foregoing set of two adjacent battery cells 20 are electrically connected to each other via the Y2-side bus bar 40. With this configuration, the plurality of battery cells 20 are connected in series. Alternatively, the plurality of battery cells 20 may be electrically connected in the following manners. Note that also in the following cases, the first channel 50 is provided for each Y1-side bus bar 30, and the second channel 60 is provided for each Y2-side bus bar 40.

As illustrated in FIG. 15, the Y1-side tabs 23 of each set of four adjacent battery cells 20 may be electrically connected to each other via a set of three Y1-side bus bars 30. The Y2-side tabs 24 of each set of four adjacent battery cells 20 that is shifted by two battery cells from the aforementioned set of four adjacent battery cells 20 may be electrically connected to each other via a set of three Y2-side bus bars 40. In this case, a plurality of parallel-connected bodies each composed of two adjacent battery cells 20 are connected in series.

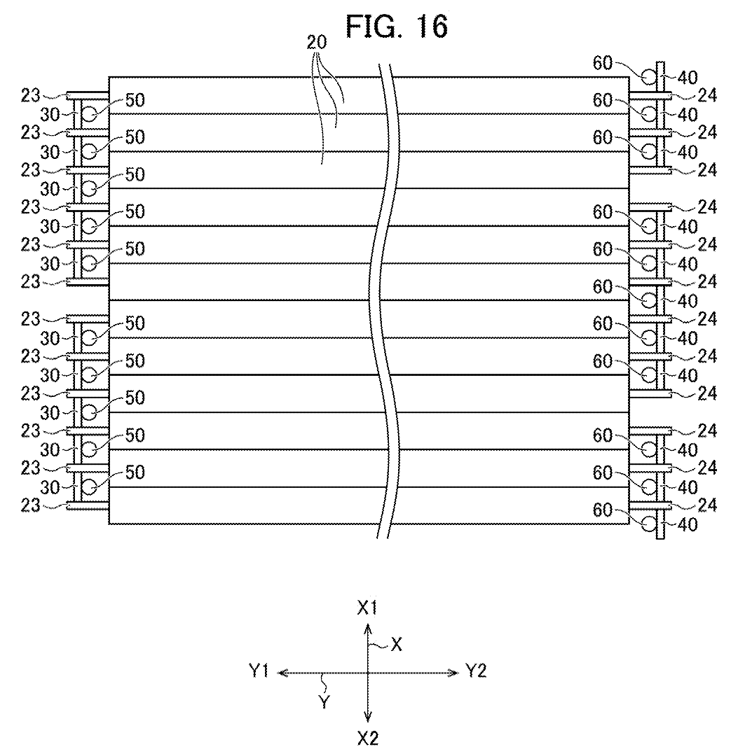

As illustrated in FIG. 16, the Y1-side tabs 23 of each set of six adjacent battery cells 20 may be electrically connected to each other via a set of five Y1-side bus bars 30. The Y2-side tabs 24 of each set of six adjacent battery cells 20 that is shifted by three battery cells from the aforementioned set of six adjacent battery cells 20 may be electrically connected to each other via a set of five Y2-side bus bars 40. In this case, a plurality of parallel-connected bodies each composed of three adjacent battery cells 20 are connected in series.

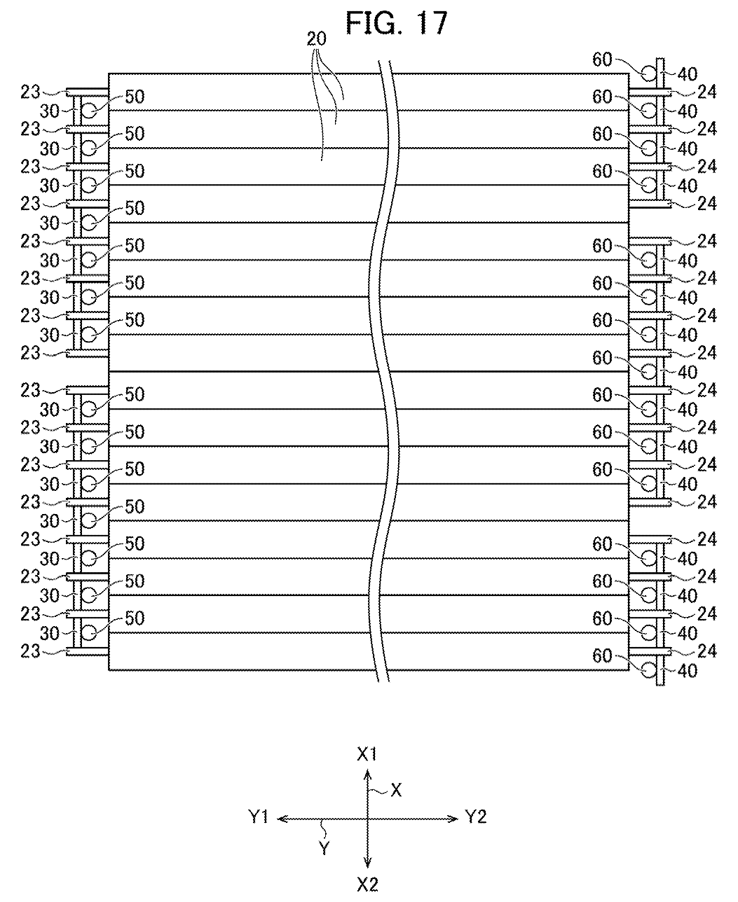

As illustrated in FIG. 17, the Y1-side tabs 23 of each set of eight adjacent battery cells 20 may be electrically connected to each other via a set of seven Y1-side bus bars 30. The Y2-side tabs 24 of each set of eight adjacent battery cells 20 that is shifted by four battery cells from the aforementioned set of eight adjacent battery cells 20 may be electrically connected to each other via a set of seven Y2-side bus bars 40. In this case, a plurality of parallel-connected bodies each composed of four adjacent battery cells 20 are connected in series.

### EXPLANATION OF REFERENCE NUMERALS

20: Battery cell

22: Cell body

229: Laminate film sealing portion (sealing portion)

23: Y1-side tab

24: Y2-side tab

30: Y1-side bus bar

40: Y2-side bus bar

50: First channel

50u: Upper path (path)

53: X1-side branch channel

54: X2-side branch channel

60: Second channel

60u: Upper path (path)

63: X1-side branch channel

64: X2-side branch channel

70: Y1-side bus bar holder

80: Y2-side bus bar holder

90u: Upper cooling plate (cooling plate)

90d: Lower cooling plate (cooling plate)

100: Battery module

What is claimed is:

1. A battery module comprising:
a plurality of battery cells stacked in a predetermined X direction,
each of the plurality of battery cells including a cell body, a Y1-side tab protruding from the cell body toward a Y1 side that is one side in a Y direction orthogonal to the X direction, and a Y2-side tab protruding from the cell body toward a Y2 side that is an opposite side to the Y1 side;
a Y1-side bus bar to which the Y1-side tab is electrically connected;
a Y2-side bus bar to which the Y2-side tab is electrically connected;
a first channel in which a coolant flows through a path that cools the Y1-side bus bar and the cell body; and
a second channel in which a coolant flows through a path that cools cooling the Y2-side bus bar and the cell body.

2. The battery module according to claim 1, wherein
the first channel includes a path through which the coolant flows so as to cool the Y1-side bus bar, and thereafter, the cell body, and
the second channel includes a path through which the coolant flows so as to cool the Y2-side bus bar, and thereafter, the cell body.

3. The battery module according to claim 1, wherein
one side in the X direction is referred to as an X1 side, and an opposite side to the X1 side is referred to as an X2 side,
when counting from the X1 side toward the X2 side, the Y1-side tab of each odd-numbered battery cell and the Y1-side tab of the battery cell next to the odd-numbered battery cell toward the X2 side are electrically connected to each other via the Y1-side bus bar, and
when counting from the X1 side toward the X2 side, the Y2-side tab of each even-numbered battery cell and the Y2-side tab of the battery cell next to the even-numbered battery cell toward the X2 side are electrically connected to each other via the Y2-side bus bar.

4. The battery module according to claim 1, further comprising:
a Y1-side bus bar holder that holds a plurality of the Y1-side bus bars;
a Y2-side bus bar holder that holds a plurality of the Y2-side bus bars; and
a cooling plate provided between the Y1-side bus bar holder and the Y2-side bus bar holder, wherein
the first channel passes through an inside of the Y1-side bus bar holder, an inside of the cooling plate, and an inside of the Y2-side bus bar holder, and
the second channel passes through the inside of the Y2-side bus bar holder, the inside of the cooling plate, and the inside of the Y1-side bus bar holder.

5. The battery module according to claim 4, wherein
a plurality of the cell bodies have sealing portions on a one-by-one basis, the sealing portions protruding in a direction orthogonal to the X direction, and
at least a portion of the cooling plate is disposed between the sealing portions of the battery cells adjacent to each other in the X direction.

6. The battery module according to claim 4, wherein
the Y1-side bus bar holder has a first inlet as an inlet for the coolant that is to flow into the first channel, and the Y2-side bus bar holder has a first outlet as an outlet for the coolant that has passed through the first channel, the first outlet being provided at a position higher than the first inlet, and
the Y2-side bus bar holder has a second inlet as an inlet for the coolant that is to flow into the second channel, and the Y1-side bus bar holder has a second outlet as an outlet for the coolant that has passed through the second channel, the second outlet being provided at a position higher than the second inlet.

7. The battery module according to claim 1, wherein
each channel of a plurality of the first channels and a plurality of the second channels includes an X1-side branch channel and an X2-side branch channel arranged side by side in the X direction, the X1-side branch channel cools one of two cell bodies adjacent to the channel, and the X2-side branch channel cools the other of the two cell bodies.

8. The battery module according to claim 1, wherein the battery cells each include a solid electrolyte.

9. The battery module according to claim 1, wherein the battery cells each include an electrolytic solution.
